(19) United States
(12) Patent Application Publication
(10) Pub. No.: US 2025/0211687 A1
(43) Pub. Date: Jun. 26, 2025

(54) IMAGE-FORMING APPARATUS, METHOD AND DISPLAY APPARATUS

(71) Applicant: CANON KABUSHIKI KAISHA, Tokyo (JP)

(72) Inventor: AKIRA HANATANI, Chiba (JP)

(21) Appl. No.: 18/978,090

(22) Filed: Dec. 12, 2024

(30) Foreign Application Priority Data
Dec. 21, 2023 (JP) 2023-216194

(51) Int. Cl. H04N 1/00; H04N 1/60

(52) U.S. Cl. CPC H04N 1/00045; H04N 1/00015; H04N 1/00037; H04N 1/00082; H04N 1/0044; H04N 1/6041; H04N 1/6044; H04N 2201/0094

(57) ABSTRACT

An image-forming apparatus includes an image-forming unit that forms a user image on a sheet and a reading unit that reads the sheet. The image-forming unit forms a pattern for adjusting an image-forming condition on the sheet with the user image. The pattern is arranged in an end section of the sheet. The image-forming condition is adjusted based on a detection result of the pattern in a read image. A display object representing the pattern is displayed on a preview screen according to an arrangement of the pattern on the sheet. In response to a user input, the apparatus changes the arrangement of the pattern on the sheet from one of end sections in main-scanning and sub-scanning directions to the other, and causes the display object to be displayed according to the changed arrangement of the pattern.

### BACKGROUND OF THE INVENTION

### Field of the Invention

The present disclosure relates to an image-forming apparatus, a method and a display apparatus.

### Description of the Related Art

Conventionally, a technique is known that uses a reader to read a sheet on which an image has been formed by an image-forming apparatus, and automatically adjusts image-forming conditions based on the read image.

For example, Japanese Patent Laid-Open No. 2012-53089 discloses a technique to use a gamma curve, which is generated based on the result of reading of a tone pattern formed on a sheet using an optical sensor, in the adjustment of density output conditions of an image-forming apparatus for each of a plurality of color components that compose a color image. Japanese Patent Laid-Open No. 2012-53089 presents an example in which a tone pattern is formed in a peripheral region of a sheet that is expected to be separated by way of trimming.

### SUMMARY OF THE INVENTION

Some users may arrange contents also in a peripheral region of a sheet. For example, a user may arrange a code used for job management or content management (e.g., a serial number, a one-dimensional barcode, or a two-dimensional barcode), a unique color patch, or the like in a peripheral region of an input image. If a pattern for adjustment of image-forming conditions overlaps a user's content on a sheet, the overlap may lead to a failure in adjustment of the image-forming conditions caused by inaccurate reading of this pattern, or exert negative effects on job management or content management that uses a content image. For this reason, there has been a demand for a mechanism that enables appropriate arrangement of a pattern for adjustment.

In view of the foregoing issues, the present invention aims to provide a mechanism that enables appropriate arrangement of a pattern for adjustment, which is used in the adjustment of image-forming conditions, while avoiding an overlap between the pattern for adjustment and a content image of a user.

According to one aspect, there is provided an image-forming apparatus, including: an image-forming unit configured to form a user image on a sheet based on at least one image-forming condition; a reading unit configured to generate a read image by optically reading the sheet; and a control unit configured to cause a display unit to display a preview screen related to the user image formed by the image-forming unit. The image-forming unit is capable of forming a pattern for adjustment on the sheet together with the user image, the pattern for adjustment being used for adjustment of the at least one image-forming condition. The pattern for adjustment is arranged in an end section of the sheet in a main-scanning direction or an end section of the sheet in a sub-scanning direction that is perpendicular to the main-scanning direction. The image-forming apparatus further comprises an adjustment unit configured to adjust the at least one image-forming condition based on a result of detection of the pattern for adjustment in the read image generated by the reading unit. The control unit is configured to cause the preview screen to display a display object representing the pattern for adjustment in accordance with an arrangement of the pattern for adjustment on the sheet. The control unit is configured to, in response to a user input for instructing to change the arrangement of the pattern for adjustment, change the arrangement of the pattern for adjustment on the sheet from one of the end section in the main-scanning direction and the end section in the sub-scanning direction to the other, and cause the display object to be displayed on the preview screen in accordance with the changed arrangement of the pattern for adjustment. A corresponding method and display apparatus are also provided.

Further features of the present invention will become apparent from the following description of exemplary embodiments (with reference to the attached drawings).

### BRIEF DESCRIPTION OF THE DRAWINGS

FIG. 1 is a schematic diagram showing an example of a configuration of a printing system according to an embodiment.

FIG. 2 is a block diagram showing an example of a more detailed configuration of a reader unit related to automatic adjustment of image-forming conditions.

FIG. 3 is a schematic diagram showing an example of a configuration of a line sensor.

FIG. 4 is a schematic diagram showing an example of a configuration of a compact spectral sensor.

FIG. 5 is a block diagram showing an example of a configuration of a controller related to automatic adjustment of image-forming conditions.

FIG. 6 is an explanatory diagram showing an example of a pattern for adjustment formed on a sheet.

FIG. 7 is a block diagram showing an example of a detailed configuration of a detection circuit.

FIG. 8 is an explanatory diagram showing an example of a pattern for correction formed on a sheet.

FIG. 9 is an explanatory diagram showing an example of a configuration of a print setting screen.

FIG. 10 is an explanatory diagram showing a first example of a configuration of a preview screen.

FIG. 11 is an explanatory diagram showing a second example of a configuration of a preview screen.

FIG. 12 is an explanatory diagram for describing changing of the arrangement of patterns for adjustment via the preview screen of FIG. 11.

FIG. 13 is an explanatory diagram showing an example of a pattern for adjustment that has been changed in arrangement.

FIG. 14 is a flowchart showing an example of a flow of job execution processing according to an embodiment.

FIG. 15 is an explanatory diagram showing a state where changing of the arrangement of patterns for adjustment is prohibited on a preview screen.

FIG. 16 is an explanatory diagram for describing changing of the arrangement of patterns for adjustment in a certain modified example.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <1. Overview of System>

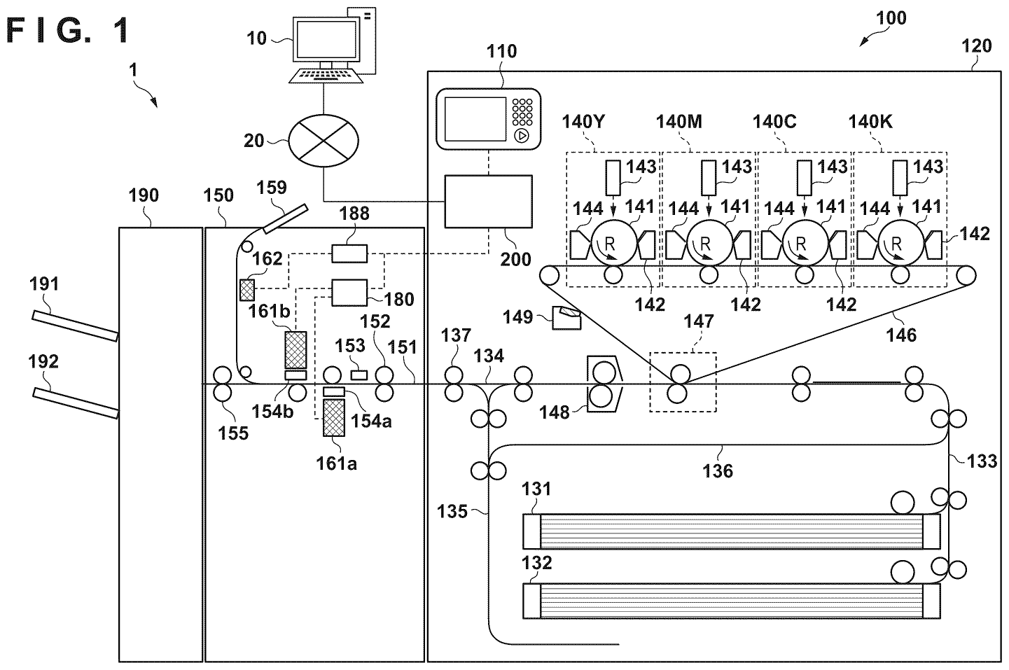

FIG. 1 is a schematic diagram showing a configuration of a printing system 1 according to an embodiment. Referring to FIG. 1, the printing system 1 includes a host computer 10 and an image-forming apparatus 100. The host computer 10 is connected to the image-forming apparatus 100 via a network 20. The network 20 may be a wired communication network, or may be a wireless communication network. For example, the network 20 may include one or more of a local area network (LAN), a wide area network (WAN), and a public communication line. Although FIG. 1 shows one host computer 10 and one image-forming apparatus 100, the printing system 1 may include a larger number of host computers and image-forming apparatuses.

The host computer 10 is an apparatus that issues a print job to be executed by the image-forming apparatus 100. As an example, the host computer 10 may be a terminal apparatus, such as a personal computer (PC) and a smartphone, provided with a user interface that includes a display. As another example, the host computer 10 may be a server apparatus that accepts a printing request from another terminal apparatus (not shown) and issues a print job. Typically, a print job includes input image data that represents a user image to be printed, and additionally includes such job parameters as the number of copies to be printed, a designated sheet type (e.g., size), and double-sided/single-sided.

The image-forming apparatus 100 is an apparatus that forms an image on a sheet by executing a print job. In the present embodiment, it is assumed that the image-forming apparatus 100 is a color laser printer capable of printing a color image using an electrophotographic method. In another embodiment, the image-forming apparatus 100 may be any other type of image-forming apparatus, such as a monochrome laser printer or an inkjet printer.

### <2. Configuration of Image Forming Apparatus>

As shown in FIG. 1, the image-forming apparatus 100 includes an operation panel 110, a printer unit 120, a reader unit 150, a finisher 190, and a controller 200.

### <2-1. Operation Panel>

The operation panel 110 is a unit that provides user interfaces (UIs) including an input interface and an output interface. The input interface can include one or more of buttons, numeric keys, a touch panel, switches, and a microphone, for example. The output interface can include one or more of a display, a speaker, and a lamp, for example. The operation panel 110 accepts a user input via the input interface, and outputs the accepted user input to the controller 200. Furthermore, the operation panel 110 outputs information generated by the controller 200 via the output interface (e.g., causes the display to display an image, or causes the speaker to output sounds). A user can instruct the image-forming apparatus 100 to execute a job and change job-related settings by operating the operation panel 110, for example.

### <2-2. Printer Unit>

The printer unit 120 is an image-forming unit that forms an image on a sheet based on at least one image-forming condition. In the example of FIG. 1, the printer unit 120 includes paper feeding trays 131 and 132, image-forming units 140Y, 140M, 140C, and 140K, an intermediate transfer member 146, a transfer unit 147, a fixing device 148, and a cleaner 149.

Each of the paper feeding trays 131 and 132 stores a stack of sheets. It is assumed here that the paper feeding tray 131 stores sheets of a first size (e.g., A4), and the paper feeding tray 132 stores sheets of a second size (e.g., A5) smaller than the first size. Although FIG. 1 shows two paper feeding trays 131 and 132, the number of paper feeding trays included in the image-forming apparatus 100 is not limited to two. When a print job is executed, sheets are picked up, one by one, by a feeding mechanism from the paper feeding tray 131 or 132 (e.g., the paper feeding tray corresponding to the size designated by a job parameter), and conveyed along a conveyance path 133.

The image-forming unit 140Y forms a yellow (Y) toner image on the intermediate transfer member 146. The image-forming unit 140M forms a magenta (M) toner image on the intermediate transfer member 146. The image-forming unit 140C forms a cyan (C) toner image on the intermediate transfer member 146. The image-forming unit 140K forms a black (K) toner image on the intermediate transfer member 146. As the image-forming units 140Y, 140M, 140C, and 140K are configured in the same way as one another, the following description will be provided using the configuration of the image-forming unit 140Y as an example. The image-forming unit 140Y includes a photosensitive drum 141, a charging device 142, an exposure device 143, and a developing device 144. The photosensitive drum 141 is a drum-shaped photosensitive member that includes a photosensitive layer on a surface thereof. The photosensitive drum 141 rotates about a drum axis in the direction of arrow R in the figure. The charging device 142 uniformly charges the surface of the rotating photosensitive drum 141. The exposure device 143 irradiates the photosensitive drum 141 with laser light in accordance with image data (that represents a yellow image in the present case) input from the controller 200. The laser light output from the exposure device 143 scans the surface of the charged photosensitive drum 141 in the direction of the drum axis, thereby forming an electrostatic latent image on the surface of the photosensitive drum 141. In the following description, the direction of scanning with the laser light (the depth direction in FIG. 1) is also referred to as a main-scanning direction, and the direction that is perpendicular to the main-scanning direction on the surface of the drum or sheet is also referred to as a sub-scanning direction. The developing device 144 develops the electrostatic latent image on the photosensitive drum 141 by supplying toner (in yellow in the present case) to the surface of the photosensitive drum 141. As a result, a toner image is formed on the surface of the photosensitive drum 141. The yellow toner image that has been formed on the surface of the photosensitive drum 141 in the image-forming unit 140Y is transferred to the intermediate transfer member 146. Furthermore, magenta, cyan, and black toner images that have been respectively formed on the surfaces of the photosensitive drums 141 in the image-forming units 140M, 140C, and 140K are sequentially transferred to the intermediate transfer member 146 in such a manner that they are superimposed over the yellow toner image. As a result, a full-color toner image is formed on the intermediate transfer member 146. The intermediate transfer member 146 is an endless belt member, and rotates in the clockwise direction in the figure. The intermediate transfer member 146 conveys the full-color toner image to the position of the transfer unit 147 (transfer nip).

Under control of the controller 200, the sheet that has been picked up from the paper feeding tray 131 or 132 is conveyed to the transfer nip in harmony with the timing of arrival of the toner image on the intermediate transfer member 146 at the transfer nip. The transfer unit 147 transfers the toner image carried by the intermediate transfer member 146 to the sheet at the transfer nip. The fixing device 148 includes a heater and a pressurizing roller. The fixing device 148 heats the toner image transferred to the sheet using the heater, and pressurizes the same using the pressurizing roller. As a result, the toner on the sheet is fused, and the toner image is fixed to the sheet. Although FIG. 1 shows an example in which the image-forming apparatus 100 includes one fixing device 148, the image-forming apparatus 100 may further include a second fixing device that is used to, for example, increase glossiness or improve the fixing performance. The cleaner 149 is arranged downstream relative to the transfer nip along the trajectory of the intermediate transfer member 146, and removes toner remaining on the intermediate transfer member 146 after the transfer of the toner image.

The conveyance path 133 bifurcates into conveyance paths 134 and 135 in a section that is downstream relative to the fixing device 148. The sheet that has passed through the fixing device 148 is conveyed from the conveyance path 133 to the conveyance path 135. When a trailing end of the sheet has entered the conveyance path 135, the conveyance direction is reversed, and the sheet is discharged from a discharge roller 137 to the reader unit 150. Through this conveyance, the sheet is discharged in a state where the surface thereof on which the image has been formed is facing downward (called face-down). Note that in a case where double-sided printing is performed, the sheet that has entered the conveyance path 135 is conveyed to a conveyance path 136, returns to the conveyance path 133 from the conveyance path 136, and passes through the transfer nip again in a state where the front and back thereof have been inverted. The transfer unit 147 forms a toner image on the back surface of the sheet at the transfer nip, and the fixing device 148 fixes the toner image on the sheet. Once the images have been formed on both surfaces of the sheet, the sheet is discharged from the discharge roller 137 to the reader unit 150.

In the present embodiment, the image-forming apparatus 100 has a function of automatically adjusting image-forming conditions on the printer unit 120. For the automatic adjustment of the image-forming conditions, the printer unit 120 is capable of forming one or more patterns for adjustment, together with a user image (or separately from the user image), on the sheet. For example, the image-forming conditions include a condition related to the density of an image formed by the printer unit 120. In this case, the patterns for adjustment include one or more tone patterns used in automatic adjustment of the density. The automatic adjustment of the image-forming conditions that uses such patterns for adjustment will be described below in detail.

### <2-3. Reader Unit>

The reader unit 150 is a reading unit that generates a read image by optically reading a sheet. In the example of FIG. 1, the reader unit 150 includes a conveyance path 151, a conveyance roller 152, a document sensor 153, a feed-scanning glass 154a, a feed-scanning glass 154b, a conveyance roller 155, a first line sensor 161a, a second line sensor 161b, a compact spectral sensor 162, an evacuation tray 159, and a detection circuit 180. The conveyance roller 152 receives a sheet discharged from the image-forming apparatus 100, and conveys the sheet along the conveyance path 151. The document sensor 153 may be, for example, a photointerrupter that includes a light-emitting element and a light-receiving element, and detects a leading end of the sheet that has passed through the conveyance roller 152. The first line sensor 161a generates read image data by optically reading the lower surface of the sheet that passes over the feed-scanning glass 154a, and outputs the generated read image data to the detection circuit 180. The second line sensor 161b generates read image data by optically reading the upper surface of the sheet that passes underneath the feed-scanning glass 154b, and outputs the generated read image data to the detection circuit 180. The first line sensor 161a and the second line sensor 161b may be, for example, contact image sensors (CISs). The timings at which the first line sensor 161a and the second line sensor 161b read the sheet can be controlled by the controller 200 based on the timing of detection of the leading end of the sheet by the document sensor 153. Note that in the following description, when it is not necessary to distinguish the first line sensor 161a and the second line sensor 161b from each other, they will be collectively referred to as line sensors 161 by omitting the alphabets at the end of the reference signs. In a section that is downstream relative to the second line sensor 161b, the conveyance path 151 bifurcates into a path leading to the finisher 190 via the conveyance roller 155 and a path leading to the compact spectral sensor 162. A normal sheet on which a user image (and patterns for adjustment) is formed is conveyed to the former, and discharged to the finisher 190 by the conveyance roller 155. In a case where correction of density unevenness in the main-scanning direction, which will be described below, is performed, a sheet on which a pattern for correction is formed is conveyed to the latter. The compact spectral sensor 162 optically reads the pattern for correction on this sheet. The sheet that has passed through the compact spectral sensor 162 is discharged to the evacuation tray 159.

### <2-4. Finisher>

The finisher 190 is a post-processing unit that executes post-processing with respect to a sheet on which an image has been formed. In the present embodiment, the finisher 190 receives a sheet discharged from the reader unit 150, conveys the sheet along an internal conveyance path, and discharges the sheet to one of discharge trays 191 and 192 (e.g., the discharge tray designated by a job parameter). The post-processing executed by the finisher 190 may include one or more of grouping, trimming, stapling, sorting, and bookbinding. For example, in a case where the finisher 190 includes a trimming mechanism (not shown), the trimming mechanism cuts off a peripheral region of the sheet by trimming the sheet in accordance with a designated size. A segment of the sheet that has been cut off can be discarded into a purge tray (not shown) inside the finisher 190.

### <2-5. Controller>

The controller 200 controls all of the above-described operations of the image-forming apparatus 100. For example, in a case where the user has issued an instruction for executing a print job, the controller 200 controls the image-forming apparatus 100 to form a user image on a sheet based on input image data. Also, in the present embodiment, in a case where it has been determined that automatic adjustment is to be performed, the controller 200 controls the printer unit 120 to form patterns for adjustment on a sheet. Automatic adjustment of image-forming conditions may be performed, for example, in a case where the user has issued an instruction therefor, or in a case where an execution timing has arrived when the automatic adjustment has been set to be performed regularly. A more detailed configuration related to the automatic adjustment of the image-forming conditions will be further described in the next section. In addition, in a certain embodiment example, the controller 200 controls the printer unit 120 to form a pattern for correction, which is used for correction of density unevenness, on a sheet prior to the execution of the print job. A configuration related to correction of density unevenness will be further described below.

### <3. Automatic Adjustment of Image-Forming Conditions>

### <3-1. Detailed Configuration of Reader Unit>

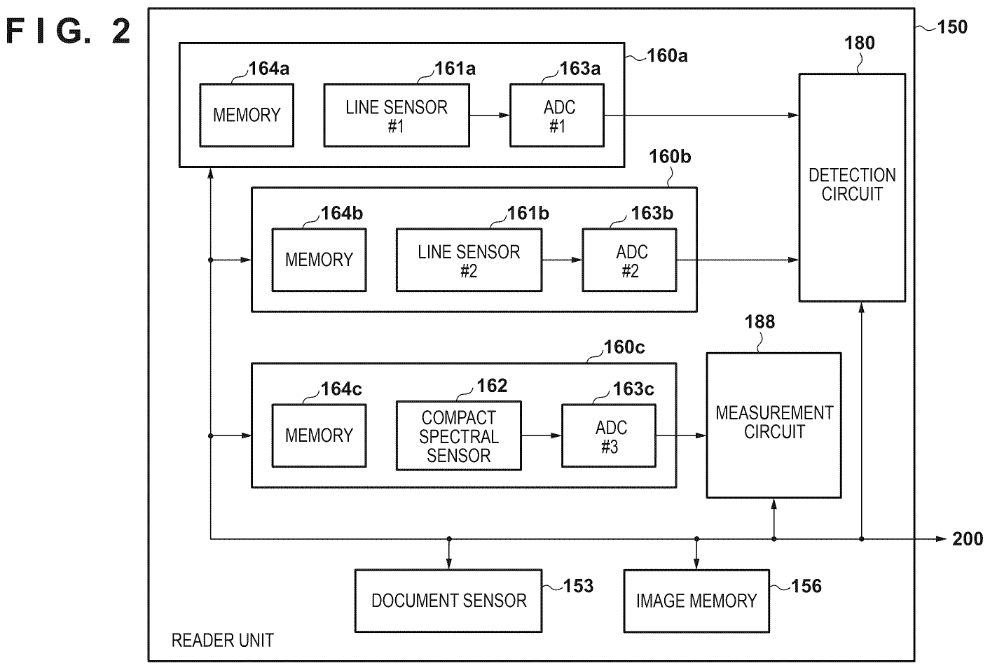

FIG. 2 is a block diagram showing an example of a more detailed configuration of the reader unit related to automatic adjustment of image-forming conditions. Referring to FIG. 2, the reader unit 150 includes a document sensor 153, an image memory 156, a first line sensor unit 160a, a second line sensor unit 160b, a spectral sensor unit 160c, a detection circuit 180, and a measurement circuit 188. The first line sensor unit 160a includes a first line sensor 161a, a first analog-digital converter (ADC) 163a, and a memory 164a. The second line sensor unit 160b includes a second line sensor 161b, a second ADC 163b, and a memory 164b. The spectral sensor unit 160c includes a compact spectral sensor 162, a third ADC 163c, and a memory 164c.

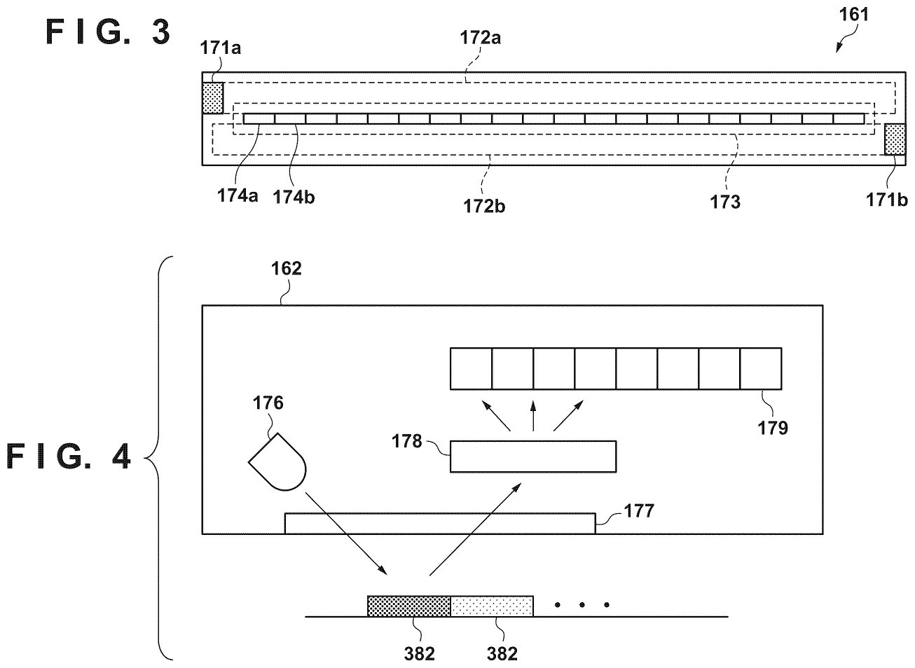

FIG. 3 is a schematic diagram showing an example of a configuration of the line sensors 161 (the first line sensor 161a and the second line sensor 161b). Referring to FIG. 3, the line sensors 161 include light sources 171a and 171b, light-guiding members 172a and 172b, a lens array 173, and a plurality of sensor chips 174a, 174b, . . . (also referred to as a sensor chip group 174). Each of the light sources 171a and 171b may be, for example, a light-emitting diode (LED) that emits while light. The light-guiding member 172a directs light emitted from the light source 171a toward a sheet while diffusing the light. The light-guiding member 172b directs light emitted from the light source 171b toward the sheet. The light-guiding members 172a and 172b include linear optical paths parallel to the main-scanning direction of the sheet; accordingly, the entirety of each line parallel to the main-scanning direction of the sheet being conveyed is irradiated with white light. The lens array 173 is an optical system that forms an image of white light reflected off the surface of the sheet on a light-receiving surface of the sensor chip group 174. The sensor chip group 174 is a collection of optical sensor chips that are arranged in a row along the main-scanning direction of the sheet. In the present embodiment, the sensor chip group 174 is composed of three rows of color filters corresponding to three color components, namely red (R), green (G), and blue (B), and three rows of photoelectric converters corresponding thereto. Each photoelectric converter receives color component light that has passed through the corresponding color filter, and generates a corresponding electrical signal. As a result, while the sheet is passing through a reading position, the line sensors 161 output an analog image signal representing an RGB image of each line composing a read image of the sheet.

Returning to FIG. 2, the first ADC 163a converts the analog image signal (representing the read image of the first surface of the sheet) input from the first line sensor 161a into read image data in a digital format, and outputs the converted read image data to the detection circuit 180. The memory 164a stores correction values used to equalize the light amounts for the respective elements of the first line sensor 161a (e.g., values corresponding to variations in the light amount). The second ADC 163b converts the analog image signal (representing the read image of the second surface of the sheet) input from the second line sensor 161b into read image data in a digital format, and outputs the converted read image data to the detection circuit 180. The memory 164b stores correction values used to equalize the light amounts for the respective elements of the second line sensor 161b.

FIG. 4 is a schematic diagram showing an example of a configuration of the compact spectral sensor 162. Referring to FIG. 4, the compact spectral sensor 162 includes a white LED 176, a transmissive window 177, a diffraction grating 178, and a light-receiving element group 179. The white LED 176 irradiates a sheet for measurement of density unevenness with white light. A pattern for correction including a plurality of line patterns 382 is formed on the sheet for measurement of density unevenness. Light reflected off the surface of the sheet on which the line patterns are formed is made incident on the diffraction grating 178. The diffraction grating 178 disperses the reflected light into a plurality of different wavelength components. Each of n light-receiving elements in the light-receiving element group 179 detects light having a corresponding wavelength component, and outputs a wavelength component signal in an analog format.

Returning to FIG. 2, the third ADC 163c converts the wavelength component signals input from the compact spectral sensor 162 into spectral sensor data in a digital format, and outputs the spectral sensor data to the measurement circuit 188. The memory 164c stores correction values used to equalize the light amounts for the respective wavelengths of the compact spectral sensor 162.

The image memory 156 stores read image data generated or processed by the reader unit 150. The detection circuit 180 is a detection unit that detects one or more patterns for adjustment within a read image in a case where image-forming conditions of the printer unit 120 are automatically adjusted. The detection circuit 180 may be implemented as a dedicated processing circuit, such as a field-programmable gate array (FPGA), an application-specific integrated circuit (ASIC), and the like, or may be implemented by a combination of a general-purpose processor and software.

In a case where image-forming conditions of the printer unit 120 are automatically adjusted, the detection circuit 180 detects each of one or more patterns for adjustment used in the automatic adjustment by searching a read image for the same. Typically, the search for each pattern for adjustment is made within a known, limited search range that is expected to include this pattern for adjustment; this is intended to shorten a processing time period. The detection circuit 180 outputs the detection result pertaining to each pattern for adjustment to the controller 200. For example, in a case where the density (density output characteristic) is automatically adjusted, the detection result can indicate density-related information pertaining to each pattern for adjustment that has been detected (e.g., average values of luminances or densities in respective patches). An example of a detailed configuration of the detection circuit 180 will be further described below.

In a case where density unevenness in the main-scanning direction is corrected, the measurement circuit 188 measures density unevenness in the main-scanning direction based on the spectral sensor data input from the spectral sensor unit 160c. The measurement circuit 188 outputs the measurement result pertaining to the patterns for correction to the controller 200. For example, for each of the four color components, the measurement result can indicate an average value of densities measured in a plurality of measurement sections obtained by dividing a line of the main-scanning direction. An example of a structure of such patterns for correction used in measurement of density unevenness will be further described below.

Note that, in place of the detection circuit 180 described above, a below-described CPU 215 of the controller 200 may have a detection function similar to that of the detection circuit 180. Similarly, in place of the measurement circuit 188 described above, the CPU 215 may have a measurement function similar to that of the measurement circuit 188. In general, various functions of the image-forming apparatus 100 described in the present specification may be realized by any combination of hardware and software.

### <3-2. Detailed Configuration of Controller>

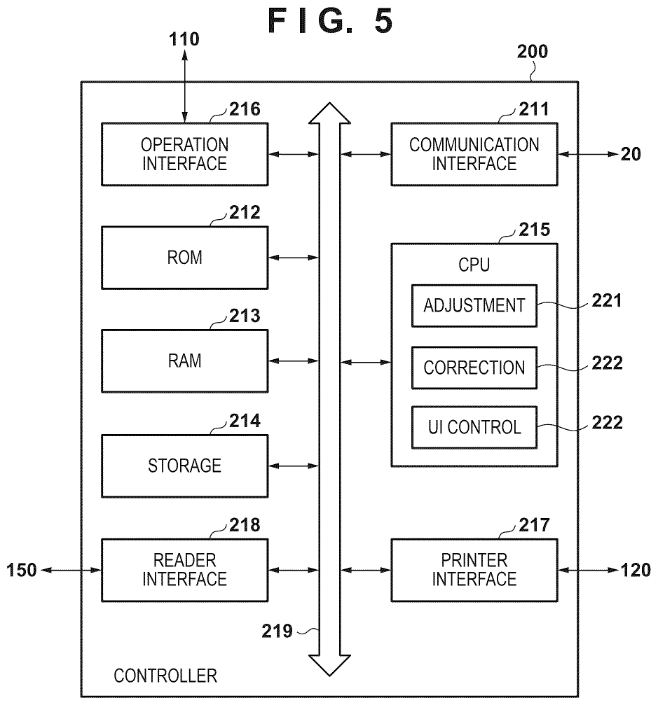

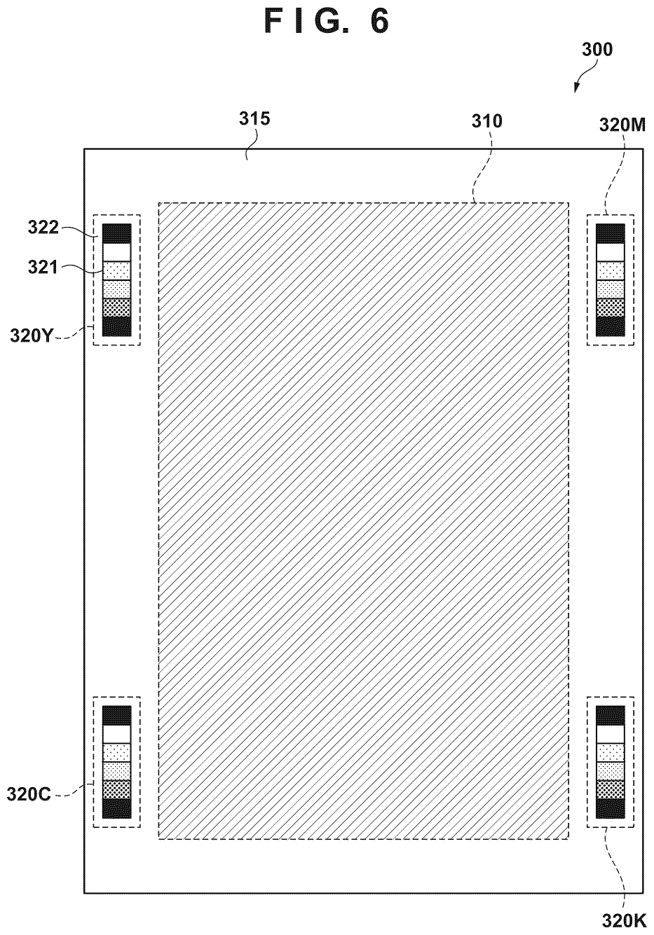

FIG. 5 is a block diagram showing an example of a more detailed configuration of the controller related to automatic adjustment of image-forming conditions. Referring to FIG. 5, the controller 200 includes a communication interface 211, a ROM 212, a RAM 213, a storage 214, a CPU 215, an operation interface 216, a printer interface 217, and a reader interface 218. These constituent elements are mutually connected via a system bus 219.

The communication interface 211 is a communication unit that is intended for the image-forming apparatus 100 to communicate with the host computer 10 and other apparatuses via the network 20. The read-only memory (ROM) 212 is a nonvolatile memory and stores, for example, one or more computer programs for the operations of the image-forming apparatus 100. The random-access memory (RAM) 213 is a volatile memory, and provides the CPU 215 with a temporary storage area for computation. The storage 214 is a large-capacity storage device, such as a hard disk drive (HDD), a solid-state drive (SSD), and the like. The storage 214 stores computer programs and various types of data, such as setting data and image data. The central processing unit (CPU) 215 is a processing circuit that realizes various control functions of the image-forming apparatus 100 by executing the computer programs stored in the ROM 212 or the storage 214. In the present embodiment, the CPU 215 functions as an adjustment unit 221, a correction unit 222, and a UI control unit 223. The adjustment unit 221 adjusts at least one image-forming condition of the printer unit 120 based on the detection results pertaining to patterns for adjustment in a read image generated by the reader unit 150. The correction unit 222 corrects density unevenness in an image formed by the printer unit 120 in the main-scanning direction. The UI control unit 223 causes a display unit to display a preview screen related to a user image formed by the printer unit 120. The display unit mentioned here may be, for example, the display of the operation panel 110 in the image-forming apparatus 100 or the host computer 10. The functions of the adjustment unit 221, correction unit 222, and UI control unit 223 will be described below in detail. The operation interface 216 is an interface for inputting/outputting signals to/from the controller 200 and the operation panel 110. The printer interface 217 is an interface for inputting/outputting data and signals to/from the controller 200 and the printer unit 120. The reader interface 218 is an interface for inputting/outputting data and signals to/from the controller 200 and the reader unit 150.

### <3-3. Automatic Adjustment Function>

### (1) Adjustment of Image-Forming Conditions

The adjustment unit 221 of the controller 200 controls the printer unit 120 to form one or more patterns for adjustment on a sheet for automatic adjustment of image-forming conditions on the printer unit 120. The patterns for adjustment may be, for example, tone patterns used in automatic adjustment of density. FIG. 6 shows a state where tone patterns, which serve as an example, are formed on a sheet 300.

Referring to FIG. 6, the sheet 300 includes a main printing region 310 and a peripheral region 315. The peripheral region 315 is a region that surrounds the outer sides of the main printing region 310. While a content of the user to be printed is arranged mainly in the main printing region 310, some sort of contents can be arranged also in the peripheral region 315. Four tone patterns 320Y, 320M, 320C, and 320K are formed in the peripheral region 315. The tone patterns 320Y, 320M, 320C, and 320K are respectively used to adjust the density output characteristics of yellow (Y), magenta (M), cyan (C), and black (K). Each tone pattern 320 is composed of a patch region 321 and a mask region 322 that surrounds the patch region 321. The patch region 321 includes a plurality of patch images of a corresponding color component, and these patch images can have different tone values. The plurality of patch images in the patch region 321 are arranged along the longitudinal direction of the tone pattern 320. The mask region 322 is a single-color region that has the same color as a background color (e.g., white). In a case where the peripheral region 315 is cut off from the sheet by way of trimming after printing, the peripheral region 315 is also referred to as a trimming region. That is to say, in the present embodiment, the printer unit 120 is capable of forming the patterns for adjustment (e.g., tone patterns) in the trimming region to be trimmed off from the sheet.

The detection circuit 180 of the reader unit 150 detects each tone pattern 320 based on read image data, extracts the patch regions 321 inside the detected tone patterns 320, and calculates an average pixel value (RGB value) for each patch image. Then, the detection circuit 180 outputs average pixel values of respective tones of each color component to the controller 200.

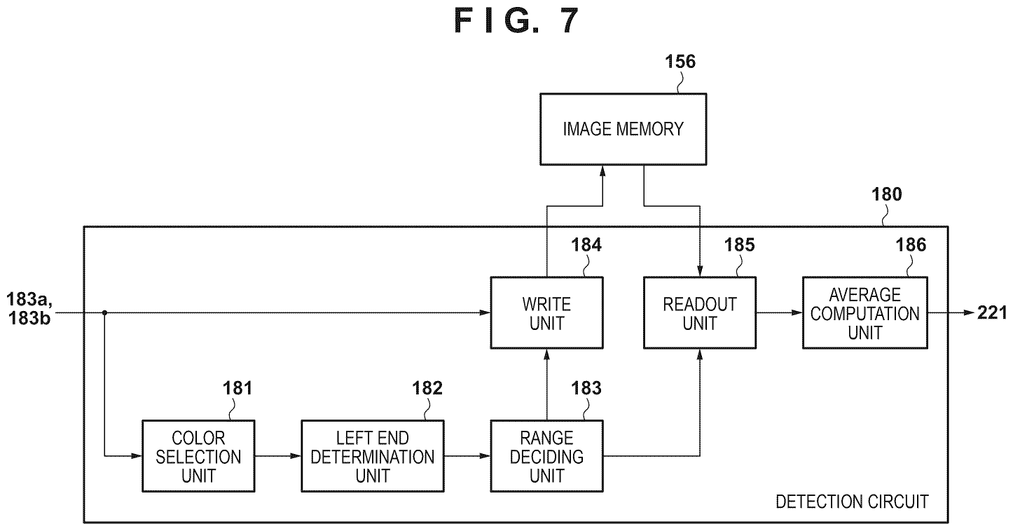

FIG. 7 is a block diagram showing an example of a detailed configuration of the detection circuit 180. Referring to FIG. 7, the detection circuit 180 includes a color selection unit 181, a left end determination unit 182, a range deciding unit 183, a write unit 184, a readout unit 185, and an average computation unit 186.

The color selection unit 181 selects an arbitrary one of RGB color component images that compose read image data. In order to detect the tone patterns 320 with favorable accuracy, this selection of a color component may be made in accordance with the background color of the sheet (e.g., a color component that exhibits the largest color difference from the background color can be selected).

The left end determination unit 182 determines the position of the left end of the patch region 321 in each tone pattern 320 to be detected within the read image of the color component selected by the color selection unit 181. Here, “left” corresponds to the upstream side in a pixel array along a line in the main-scanning direction. For example, the left end determination unit 182 may determine the left end of the patch region 321 by sequentially scanning the pixel values of each line in the read image and comparing each pixel value with a pre-defined threshold. In a case where the background color of the sheet is white, the patch region 321 can be detected in a case where a pixel value (or luminance value) falls below the threshold. In the present embodiment, the search for each pattern for adjustment based on scanning of pixel values by the left end determination unit 182 can be made within a corresponding, known search range as stated above. Note that in order to improve the determination accuracy, the left end determination unit 182 may scan the pixel values of a plurality of lines simultaneously, and determine the position of the left end of the patch region 321 using the plurality of pixel values.

The range deciding unit 183 decides on a range of each patch image to be cut out from the read image (hereinafter referred to as a cutout range) based on the result of determination made by the left end determination unit 182. For example, assume that the result of determination made by the left end determination unit 182 indicates the position coordinates of the upper-left corner of the patch region 321 in the tone pattern 320Y that has been described using FIG. 6. The range deciding unit 183 already knows the sizes of the patch region 321 in the main-scanning direction and the sub-scanning direction. Therefore, the range deciding unit 183 can decide on a cutout range of a patch image of each tone in the tone pattern 320Y based on the position coordinates of the upper-left corner and on the known sizes. The cutout range that is decided on here may be, for example, a somewhat small range obtained by excluding the vicinities of four edges of each patch image composing the patch region 321.

The write unit 184 cuts out a patch image inside each range that has been decided on by the range deciding unit 183 from the read image (RGB image), and writes patch image data indicating the patch image that has been cut out to the image memory 156. The readout unit 185 reads out the patch image data that has been written to the image memory 156, and outputs the patch image data to the average computation unit 186.

With respect to the four color components, namely Y, M, C, and K, the average computation unit 186 calculates average pixel values (RGB values) of respective tones of patch images (that have been cut out from the read image) based on each piece of patch image data input from the readout unit 185. Then, the average computation unit 186 outputs the calculated average pixel values to the adjustment unit 221 of the controller 200.

The adjustment unit 221 adjusts the density output characteristics of the image-forming units 140Y, 140M, 140C, and 140K based on the average pixel values input from the detection circuit 180. This adjustment can be made using, for example, some sort of conversion formula or lookup table that accepts a set of average pixel values as an input and outputs a parameter that specifies the density output characteristics after adjustment. As one example, in a case where the result of detection of the tone pattern 320Y indicates that the printing density is too low in the intermediate tone range of the Y component, the adjustment unit 221 may increase the density output of the intermediate tone range of the image-forming unit 140Y. As another example, in a case where the result of detection of the tone pattern 320M indicates that the printing density is too high in the low tone range of the M component, the adjustment unit 221 may reduce the density output of the low tone range of the image-forming unit 140M.

### (2) Correction of Density Unevenness

Prior to image formation by the printer unit 120, the correction unit 222 controls the printer unit 120 to form a pattern for correction on a sheet for the purpose of correction of density unevenness (i.e., equalization of density) in the main-scanning direction. In a certain embodiment example, the correction unit 222 executes correction of density unevenness only in a case where settings related to patterns for adjustment satisfy a certain condition. The condition under which the correction of density unevenness is executed will be described below.

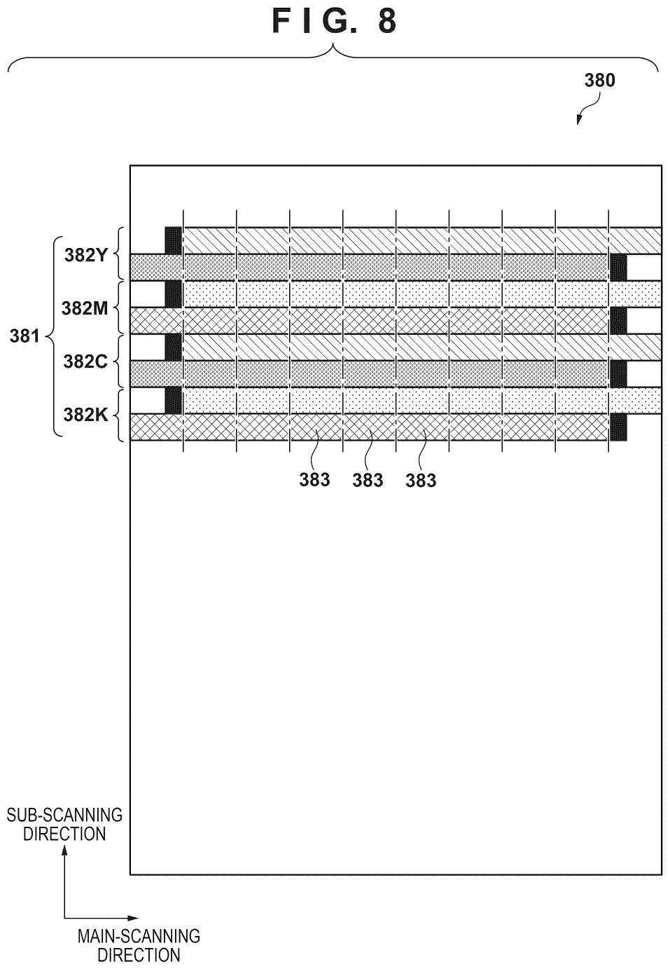

FIG. 8 shows a state where a pattern for correction 381, which serves as an example, is formed on a sheet 380. Referring to FIG. 8, the pattern for correction 381 includes four color component patterns 382Y, 382M, 382C, and 382K. The color component patterns 382Y, 382M, 382C, and 382K are respectively used to measure density unevenness of yellow (Y), magenta (M), cyan (C), and black (K). Each color component pattern 382 includes two line patterns that extend in the main-scanning direction, and each line pattern is divided into a plurality of measurement sections 383 that are lined up in the main-scanning direction. In the figure, boundaries between measurement sections 383 are indicated by dash-dot lines. Unlike the patterns for adjustment that have been described using FIG. 6, the pattern for correction 381 can be formed both in and outside the main printing region of a sheet as shown. Therefore, the pattern for correction 381 is formed on a sheet different from a sheet on which a user image is formed. Although the density of an image of each line pattern is uniform in terms of pixel values except for a small rectangular region at one end, the density can be uneven on the printed sheet due to variations in the characteristics of the printer unit 120 (i.e., density unevenness can occur).

Based on spectral sensor data input from the spectral sensor unit 160c, the measurement circuit 188 of the reader unit 150 calculates average measured values of density in the respective measurement sections 383 of each color component. Then, the measurement circuit 188 outputs the calculated average measured values to the controller 200.

For example, for each of the four color components, the correction unit 222 calculates an overall average measured value of all measurement sections in the main-scanning direction based on the average measured values of the respective measurement sections that are input from the measurement circuit 188. Then, based on the differences between this overall average measured value and the average measured values of the respective measurement sections, the correction unit 222 decides on density correction amounts for the respective measurement sections. Density correction can be made by controlling the laser power of the exposure device 143 of the corresponding image-forming unit 140 for each measurement section in accordance with the correction amount that has been decided on. For example, a correction amount may be an offset relative to a base value of the laser power, and the correction amount can be decided on so as to cancel out the difference in density from the overall average measured value.

### <4. Provision of Preview Screen>

The printer unit 120 is capable of forming the above-described patterns for adjustment intended for the automatic adjustment function in such a manner that they are superimposed over an image region in which a user image is formed on a sheet. That is to say, although the patterns for adjustment can be typically formed in a peripheral region (or a trimming region) of a sheet as has been described using FIG. 6, this peripheral region can at least partially overlap a region in which a user image is formed. Therefore, there is a possibility that one or more patterns for adjustment in a peripheral region positionally compete with contents arranged by the user. For example, the user may arrange a code used for job management or content management (e.g., a serial number or a one-dimensional or two-dimensional barcode), a mark that acts as a benchmark for a task like trimming, a unique color patch, or the like in a peripheral region of an input image. In view of this, it is assumed that the UI control unit 223 also presents a preview of each pattern for adjustment to the user on a printing preview screen that presents a preview of a user image. The arrangement of each display object on the preview screen corresponds to the arrangement on a sheet where the corresponding pattern for adjustment is to be formed. Also, it is assumed that the UI control unit 223 can accept a user input for instructing to change the arrangement of each pattern for adjustment on the sheet (changing the position, changing the direction, and the like) via a similar preview screen. For example, the preview screen can be called up from a print setting screen that is provided for settings of a print job to be executed (or any other setting screens).

### <4-1. Print Setting Screen>

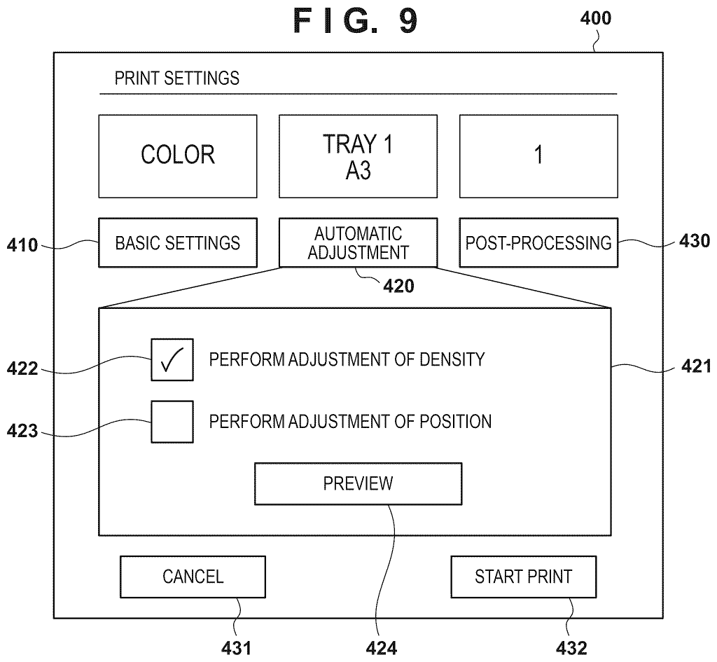

FIG. 9 is an explanatory diagram showing an example of a configuration of a print setting screen 400 that can be provided by the UI control unit 223. Referring to FIG. 9, the print setting screen 400 includes a basic setting button 410, an automatic adjustment button 420, an automatic adjustment setting area 421, a post-processing button 430, a cancel button 431, and a print start button 432.

The basic setting button 410 is a button for calling up basic setting items of a print job. The automatic adjustment button 420 is a button for calling up setting items related to the above-described automatic adjustment function of the image-forming apparatus 100. The post-processing button 430 is a button for calling up setting items related to a post-processing function of the image-forming apparatus 100. The cancel button 431 is a button for cancelling the issuance of a print job and closing the print setting screen 400. The print start button 432 is a button for issuing a print job and causing the printer unit 120 to start image formation. In the example of FIG. 9, the automatic adjustment setting area 421 is displayed on the print setting screen 400 as a result of the user operating the automatic adjustment button 420. The automatic adjustment setting area 421 includes a density adjustment checkbox 422, a position adjustment checkbox 423, and a preview button 424.

The density adjustment checkbox 422 is an object for enabling or disabling automatic adjustment of density. The position adjustment checkbox 423 is an object for enabling or disabling automatic adjustment of an image-forming position. In the example of FIG. 9, as the density adjustment checkbox 422 is ON and the position adjustment checkbox 423 is OFF, only automatic adjustment of density is enabled. In the present specification, automatic adjustment of the image-forming position is not described. The preview button 424 can be operated when at least one of the checkboxes 422 and 423 is ON. For example, if the user operates the preview button 424 in a state where only the density adjustment checkbox 422 is ON, a preview screen described next is displayed on a display.

### <4-2. Preview Screen>

### (1) First Configuration Example

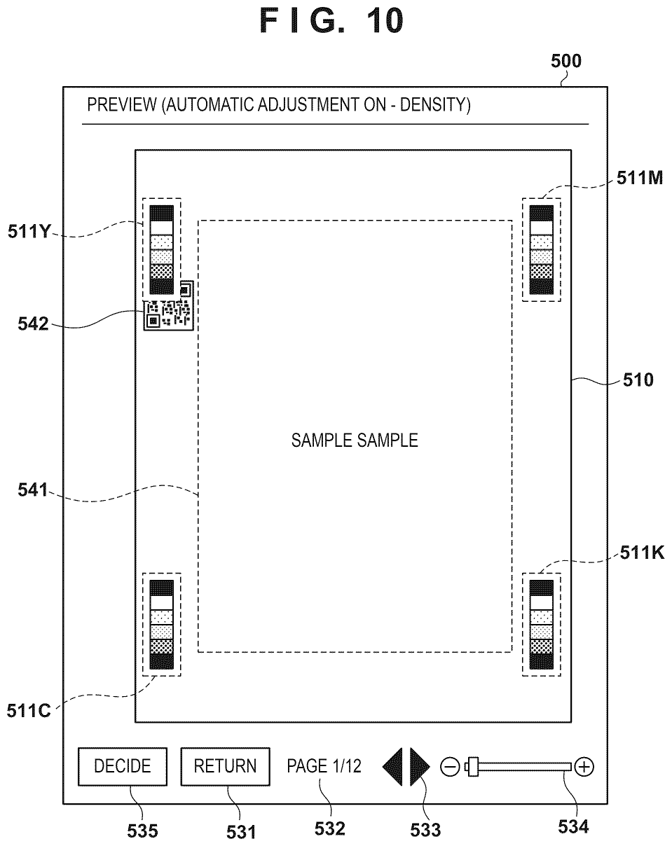

FIG. 10 is an explanatory diagram showing a first example of a configuration of a preview screen. Referring to FIG. 10, a preview screen 500 includes a preview area 510, a return button 531, a page number field 532, page transition buttons 533, a slider 534, and a decide button 535. In the preview area 510, the UI control unit 223 presents a preview of a user image based on input image data of a print job to the user. Furthermore, as automatic adjustment of density is enabled, the UI control unit 223 superimposes display objects 511Y, 511M, 511C, and 511K representing the tone patterns 320Y, 320M, 320C, and 320K over their respective display positions.

In the example of FIG. 10, the user image includes a main content 541 at the center, and also an auxiliary content 542 indicating a two-dimensional barcode. Although the auxiliary content 542 is arranged in a peripheral region on the left side of the user image, the display object 511Y corresponding to the tone pattern 320Y hides a part of the auxiliary content 542 in the preview area 510. This means that, if the print job is executed as is, a part of the auxiliary content 542 will be absent on a sheet because the tone pattern 320Y is superimposed thereon. Looking at this preview screen 500, the user can notice the necessity to rearrange the auxiliary content 542 so that it does not overlap the pattern for adjustment. Alternatively, the user can also choose to disable automatic adjustment of density in the immediate print job.

In a first configuration example shown in FIG. 10, the UI control unit 223 accepts a user input for instructing to change the arrangement of patterns for adjustment on the sheet. The user input may be a touch input on the screen, or may be an operational input via another input device (e.g., a physical button) of the operation panel 110.

For example, the patterns for adjustment are arranged in the end sections of the sheet in the main-scanning direction or the end sections thereof in the sub-scanning direction. The UI control unit 223 causes the display objects 511Y, 511M, 511C, and 511K to be displayed on the preview screen 500 in accordance with the arrangement of the patterns for adjustment on the sheet. Upon detecting the user input for instructing to change the arrangement of the patterns for adjustment, the UI control unit 223 changes the arrangement of the patterns for adjustment on the sheet from one of the end sections in the main-scanning direction and the end sections in the sub-scanning direction to the other in response to the detected user input. Then, the UI control unit 223 causes the display objects 511Y, 511M, 511C, and 511K to be displayed on the preview screen 500 in accordance with the changed arrangement of the patterns for adjustment. The UI control unit 223 may collectively change the arrangement of all patterns for adjustment (and display objects on the screen) in response to a single user input. Alternatively, the UI control unit 223 may change only the arrangement of a corresponding pattern for adjustment (and display object on the screen) in response to a user input targeted at an individual display object (e.g., tapping on an individual object).

For example, the longitudinal direction of each pattern for adjustment may be parallel to the sub-scanning direction in a first arrangement, and the longitudinal direction of each pattern for adjustment may be parallel to the main-scanning direction in a second arrangement.

In addition, upon detecting a user input for issuing an instruction for translating the patterns for adjustment, the UI control unit 223 may change the positions where the respective patterns for adjustment are formed on the sheet from first positions to second positions in response to the detected user input. Then, the UI control unit 223 causes each display object to be displayed at display positions on the preview screen 500 that correspond to the second positions on the sheet. The UI control unit 223 may collectively translate the positions of all patterns for adjustment (and display objects on the screen) in response to a single user input. Alternatively, the UI control unit 223 may translate only the position of a corresponding pattern for adjustment (and display object on the screen) in response to a user input targeted at an individual display object (e.g., dragging of an individual object).

In a case where the position of a certain pattern for adjustment has been changed to a second position, the UI control unit 223 may change a search range in which the detection circuit 180 searches for this pattern for adjustment in a read image (e.g., a range in which pixel values are scanned) to a range corresponding to the changed second position.

A user input for making such a change in arrangement may be accepted via an UI object on the preview screen as in a second configuration example described next.

The return button 531 is a button for closing the preview screen 500 and returning to the print setting screen 400. The page number field 532 is a field that displays the total number of pages and the page number of a page that is currently displayed in a case where contents to be printed extend over a plurality of pages. The page transition buttons 533 are buttons for changing a page displayed in the preview area 510 to a preceding page or a succeeding page. The slider 534 is an object that allows the scale of a preview image displayed in the preview area 510 on the screen to be changed. The decide button 535 is a button for reflecting the change in arrangement that has been made by the user on the preview screen 500 in the settings of the print job.

### (2) Second Configuration Example

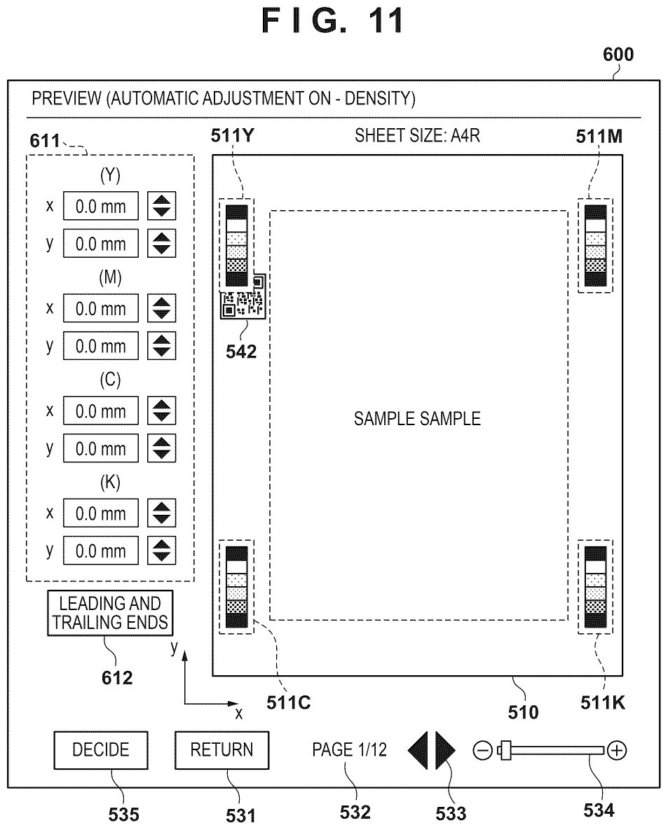

FIG. 11 is an explanatory diagram showing a second example of a configuration of a preview screen. Referring to FIG. 11, a preview screen 600 includes a preview area 510, a return button 531, a page number field 532, page transition buttons 533, a slider 534, and a decide button 535. The UI control unit 223 displays a preview of a user image based on input image data of a print job in the preview area 510. Furthermore, as automatic adjustment of density is enabled, the UI control unit 223 displays display objects 511Y, 511M, 511C, and 511K representing the tone patterns 320Y, 320M, 320C, and 320K in accordance with their respective, default arrangements.

The preview screen 600 further includes an input object 611 for issuing an instruction for translating each of the tone patterns 320Y, 320M, 320C, and 320K. The input object 611 includes four pairs of numerical value input fields to which relative movement amounts for translating each of the four tone patterns 320 in the x direction and the y direction can be input. Here, the x direction can correspond to the main-scanning direction, and the y direction can correspond to the sub-scanning direction. In addition, the preview screen 600 includes a switch button 612.

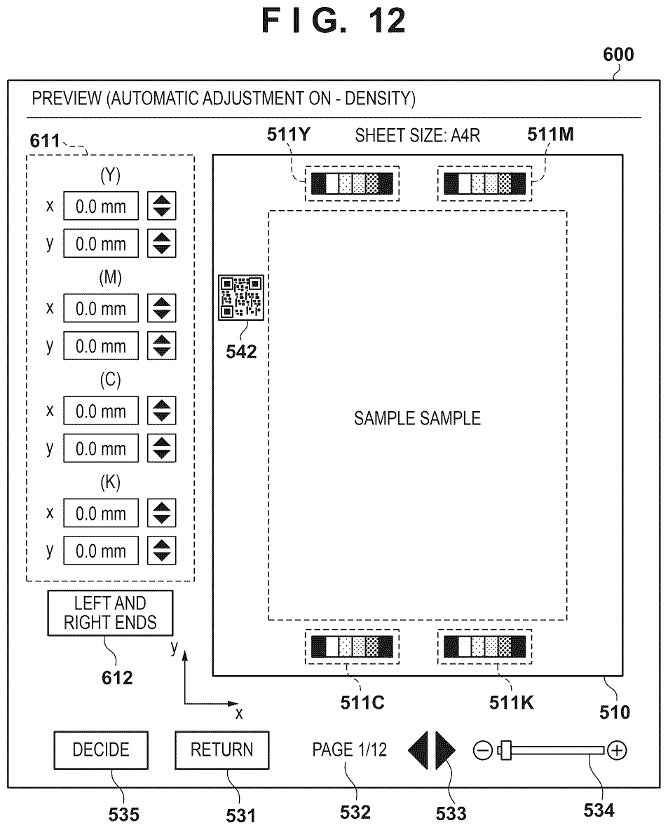

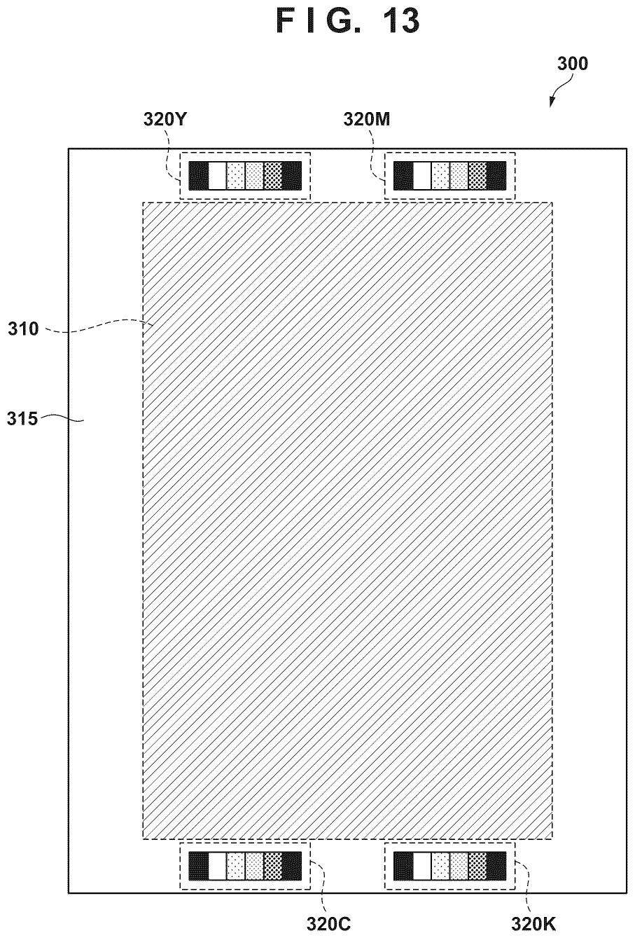

When the user has operated the switch button 612, the UI control unit 223 switches the arrangement of the tone patterns 320Y, 320M, 320C, and 320K on a sheet between the first arrangement and the second arrangement. As stated above, with the first arrangement, the tone patterns are arranged at both ends in the main-scanning direction (the left end section and the right end section). Both ends in the main-scanning direction are also referred to as left and right ends. Also, with the second arrangement, the tone patterns are arranged at both ends in the sub-scanning direction (the leading end section and the trailing end section). Both ends in the sub-scanning direction are also referred to as leading and trailing ends. FIG. 12 shows a state of the preview screen 600 after the switch button 612 has been operated. As shown in the figure, the arrangement of the display objects 511Y, 511M, 511C, and 511K, which respectively correspond to the tone patterns 320Y, 320M, 320C, and 320K, has been changed from the first arrangement to the second arrangement. As a result, the overlap between the display object 511Y and the auxiliary content 542 has been resolved. If the user operates the switch button 612 again in this state, the UI control unit 223 can change the arrangement of the tone patterns 320Y, 320M, 320C, and 320K from the second arrangement to the first arrangement.

For example, if the user operates the decide button 535 in the state shown in FIG. 12, the UI control unit 223 closes the preview screen 600 and displays the print setting screen 400 again. Then, when the user has operated the print start button 432 (see FIG. 9) on the print setting screen 400, a print job is issued, and the printer unit 120 starts image formation. In this print job, the printer unit 120 forms the patterns for adjustment on a sheet in accordance with the arrangement after the change made by the user. In a case where the user has operated the return button 531, the change in the arrangement made by the user on the preview screen 600 is cancelled.

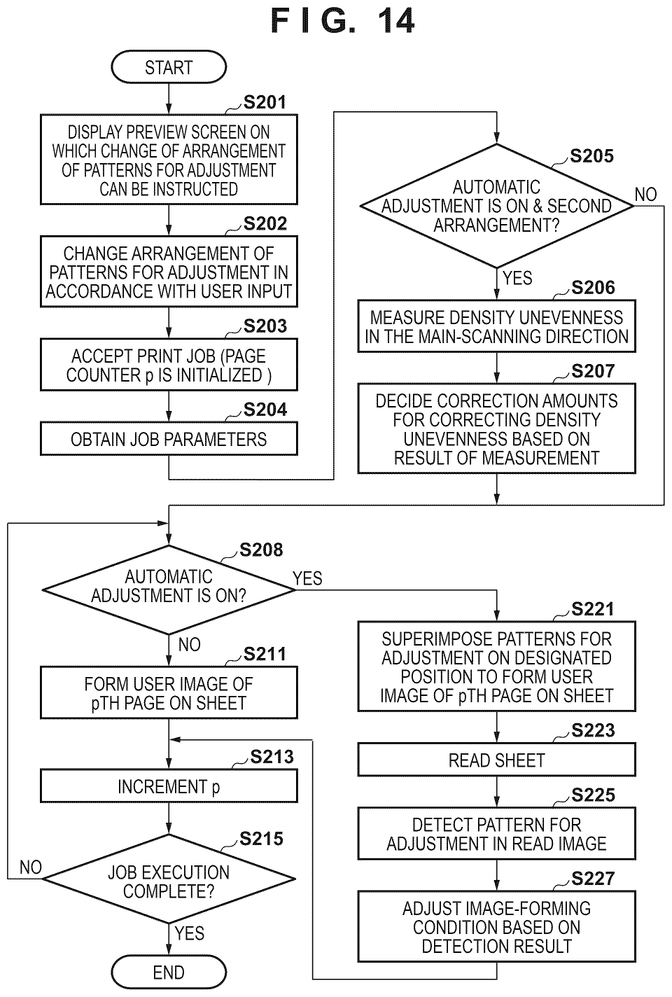

FIG. 13 shows an example of a pattern for adjustment that has been changed in arrangement. The patterns for adjustment according to the examples of FIG. 13 include four tone patterns 320Y, 320M, 320C, and 320K, which are similar to those shown in FIG. 6. However, while the four tone patterns 320 are arranged in the end sections of the sheet 300 in the main-scanning direction (left and right ends) in FIG. 6, the four tone patterns 320 are arranged in the end sections of the sheet 300 in the sub-scanning direction (leading and trailing ends) in FIG. 13.

As in the above-described embodiment example, by providing a simple user interface for switching the arrangement of the pattern for adjustment, the user is allowed to easily avoid an overlap between a pattern for adjustment and a content image.

### <4-3. Conditional Correction of Density Unevenness>

In a case where the longitudinal direction of the patterns for adjustment is parallel to the main-scanning direction (in a case where the second arrangement of the patterns for adjustment has been set), there is a possibility that density unevenness in the main-scanning direction causes an error in adjustment of image-forming conditions. In view of this, in a certain embodiment example, the UI control unit 223 causes the correction unit 222 to correct density unevenness in the main-scanning direction in a case where the patterns for adjustment are formed in the second arrangement (see FIG. 13) on a sheet. In a case where correction of density unevenness is to be performed, prior to the execution of a print job, the printer unit 120 forms the pattern for correction 381 on a sheet, the spectral sensor unit 160c reads the pattern for correction 381, and the measurement circuit 188 measures average densities in the respective measurement sections 383. At the time of execution of the print job, the correction unit 222 controls the laser power of the exposure device 143 in the image-forming unit 140 so as to cancel out the differences between the base density and the average densities in the respective measurement sections 383. By thus eliminating the influence of density unevenness from the plurality of patch images in the patterns for adjustment formed along the main-scanning direction, a reduction in the accuracy of adjustment of image-forming conditions can be prevented, and high printing quality can be maintained.

### <4-4. Flow of Processing>

FIG. 14 is a flowchart showing an example of a flow of job execution processing that can be executed by the image-forming apparatus 100.

First, in step S201, the UI control unit 223 of the controller 200 in the image-forming apparatus 100 displays a preview screen related to a print job on the display of the host computer 10 or the operation panel 110 in response to a call from the user. In a case where the function of automatically adjusting at least one image-forming condition is enabled, the preview screen displayed here includes display objects representing the patterns for adjustment. On this preview screen, a user input for changing the arrangement of such patterns for adjustment can be accepted.

Next, in step S202, in accordance with, for example, a user input accepted via the preview screen, the UI control unit 223 changes the arrangement of at least one pattern for adjustment on a sheet from a default arrangement to an arrangement designated by the user.

Next, in step S203, once the user has issued an instruction for starting the execution of the print job, the UI control unit 223 accepts the print job. The print job includes input image data representing a user image to be printed. At this time, a page counter p, which is a variable for identifying a page to be printed, is initialized to zero.

Next, in step S204, the UI control unit 223 obtains job parameters of the accepted print job. The job parameters include not only the aforementioned parameters for basic settings, but also a parameter indicating whether the automatic adjustment function is enabled for at least one image-forming condition. In a case where the automatic adjustment function is enabled, the job parameters include a parameter indicating the arrangement of one or more patterns for adjustment on the sheet (e.g., the positions and orientation after the change in step S202).

Next, in step S205, the UI control unit 223 determines whether the automatic adjustment function is enabled and the arrangement of the patterns for adjustment is the second arrangement (or the longitudinal direction of the patterns for adjustment is parallel to the main-scanning direction). In a case where the automatic adjustment function is enabled and the arrangement of the patterns for adjustment is the second arrangement, the printer unit 120 forms the pattern for correction 381 on the sheet, and the measurement circuit 188 measures average densities in the respective measurement sections 383 in step S206. Next, in step S207, based on the result of measurement of the average densities, the correction unit 222 decides on the laser power correction amounts for correcting density unevenness in the main-scanning direction for the respective measurement sections 383 with respect to each color component. In a case where the automatic adjustment function is not enabled, or there is no pattern for adjustment for which the second arrangement has been set, the aforementioned steps S206 and S207 are skipped.

Thereafter, processing bifurcates in step S208 depending on whether the automatic adjustment function is enabled. In a case where the automatic adjustment function is enabled, processing proceeds to step S221. In a case where the automatic adjustment function is not enabled, processing proceeds to step S211.

In a case where the automatic adjustment function is not enabled, in step S211, the printer unit 120 forms a user image of the p^{th} page on a sheet under control of the controller 200. Next, in step S213, the page counter p is incremented. Next, in step S215, whether the execution of the print job has been completed is determined. For example, in a case where the page counter p has not reached the total number of sheets to be printed, it is determined that the execution of the print job has not been completed, and processing returns to step S208. On the other hand, in a case where the page counter p has reached the total number of sheets to be printed, it is determined that the execution of the print job has been completed, and the flowchart of FIG. 14 is ended.

In a case where the automatic adjustment function is enabled, in step S221, the printer unit 120 forms a user image of the p^{th} page on a sheet under control of the controller 200. At this time, the adjustment unit 221 superimposes one or more patterns for adjustment used in the automatic adjustment on the user image in accordance with the arrangement indicated by the job parameters obtained in step S204. Also, in a case where the arrangement of the patterns for adjustment is the second arrangement, density unevenness is suppressed by correcting the laser power of the exposure device 143 using the correction amounts that have been decided on in step S207.

Next, in step S223, the line sensor 161 of the reader unit 150 generates a read image by optically reading the sheet on which the user image and the patterns for adjustment have been formed. Next, in step S225, the detection circuit 180 of the reader unit 150 searches the read image generated in step S223 for each of the one or more patterns for adjustment used in the automatic adjustment, and detects each pattern for adjustment. Here, in a case where the arrangement in which each pattern for adjustment is to be formed on the sheet has been changed, the range in which this pattern for adjustment is searched for has been changed in accordance with this change in the arrangement.

Next, in step S227, the adjustment unit 221 of the controller 200 adjusts the image-forming conditions of the printer unit 120 based on the detection result input from the detection circuit 180. For example, the detection result can indicate the average pixel values for the respective color components and the respective tones, which have been calculated based on the patch images in the tone patterns detected inside the read image. For example, the adjustment unit 221 converts the average pixel values into density values, and adjusts the density output characteristic of each of the image-forming units 140Y, 140M, 140C, and 140K so as to compensate for the density difference from desired density. Note that the adjustment of the density output characteristics based on reading of the tone patterns or patch images may be performed in accordance with any known method, and a detailed description thereof is omitted here.

Next, processing proceeds to step S213, and the page counter p is incremented as stated above. Next, whether the execution of the print job has been completed is determined in step S215, and processing returns to step S208 in a case where it has been determined that the execution of the print job has not been completed. On the other hand, in a case where it has been determined that the execution of the print job has been completed, the flowchart of FIG. 14 is ended.

Note that the patterns for adjustment may be superimposed only on the first page (or any page designated by the user). The adjustment of the image-forming conditions may be applied to succeeding pages in the same print job, or may be applied to a succeeding print job.

### <4-5. Modified Examples>

### (1) First Modified Example

Regarding the above-described embodiment, various modified examples can be envisaged. In a first modified example, the UI control unit 223 may control whether to accept a user input for changing the arrangement of patterns for adjustment depending on the settings of a print job. For example, the UI control unit 223 allow a user input for changing the arrangement of patterns for adjustment to be accepted in a case where the printer unit 120 has been set to form an image on a sheet of the first size. On the other hand, the UI control unit 223 does not allow this user input to be accepted in a case where the printer unit 120 has been set to form an image on a sheet of the second size smaller than the first size. For example, a sheet of the first size is A4, and a sheet of the second size is A5.

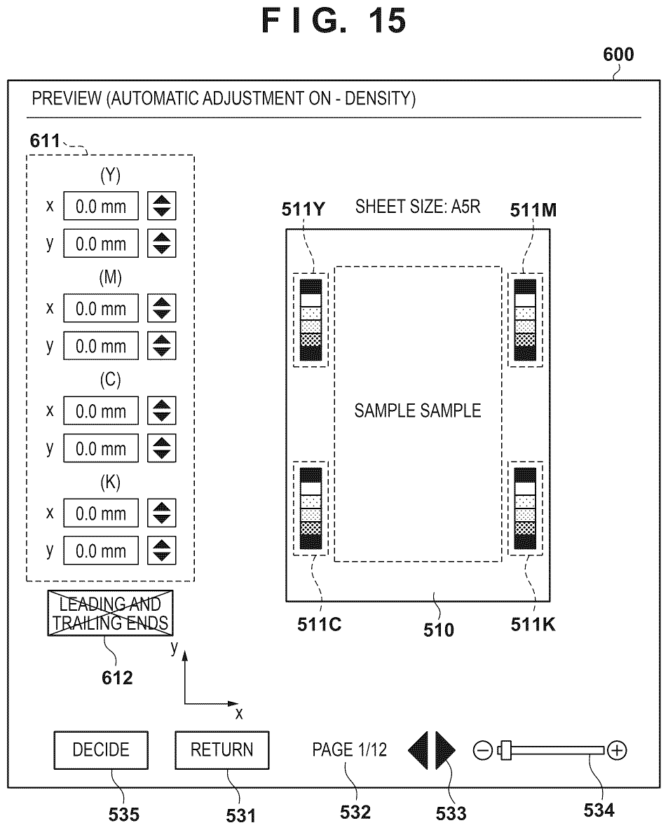

FIG. 15 shows a state where changing of the arrangement of patterns for adjustment is prohibited on a preview screen 600, which is similar to that shown in FIG. 11. In the example of FIG. 15, as the switch button 612 is disabled, the user cannot change the arrangement of the patterns for adjustment from the default arrangement. It is permitted to displace the patterns for adjustment by designating relative movement amounts of the patterns for adjustment. In particular, in a case where the sheet size is small, a situation can possibly arise where the peripheral region becomes short at the top and bottom, or left and right of the sheet, and a sufficient region size for arrangement of the patterns for adjustment cannot be secured. In view of this, by thus placing a conditional prohibition on changing of the patterns for adjustment from the default arrangement, the lack of the region for arrangement of the patterns for adjustment can be avoided, and reliable execution of the adjustment of image-forming conditions can be guaranteed.

### (2) Second Modified Example

Although the above embodiment has been described using an example in which the plurality of patch images in each pattern for adjustment are arrayed in a row and the longitudinal direction thereof is parallel to the main-scanning direction or the sub-scanning direction, the configuration of each pattern for adjustment is not limited to this example. In a second modified example, the plurality of patch images in each pattern for adjustment can be arrayed differently between the first arrangement and the second arrangement. For example, in the first arrangement, the plurality of patch images in each pattern for adjustment are arrayed in a row, and the longitudinal direction thereof is parallel to the sub-scanning direction. This first arrangement may be similar to the arrangement of the above-described display objects 511Y, 511M, 511C, and 511K of FIG. 10 and FIG. 11. On the other hand, in the second arrangement, the plurality of patch images in each pattern for adjustment are arrayed in a plurality of rows, and the number of rows thereof is selected so that the length occupied by each pattern for adjustment in the sub-scanning direction falls within a peripheral region (or trimming region) of a sheet.

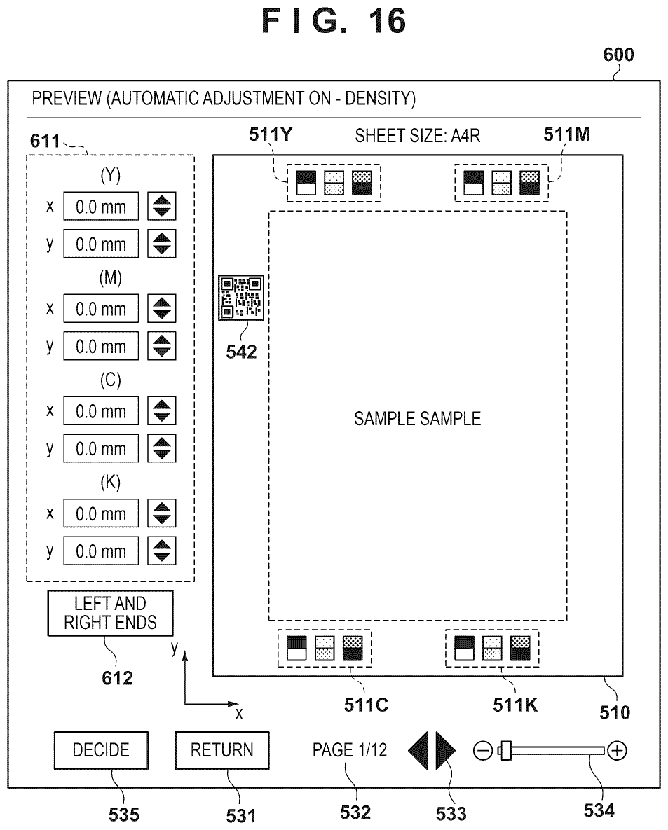

FIG. 16 shows a state of the preview screen 600 after the switch button 612 on the preview screen 600 of FIG. 11 (corresponding to the first arrangement) has been operated in the second modified example. As shown in the figure, the arrangement of the display objects 511Y, 511M, 511C, and 511K, which respectively correspond to the tone patterns 320Y, 320M, 320C, and 320K, has been changed from the first arrangement to the second arrangement. Although the positions of the four display objects in the second arrangement are substantially the same as those in the example of FIG. 12, the patch images included in each display object compose a 2×3 two-dimensional array. As a result, the length of the tone pattern corresponding to each display object in the sub-scanning direction falls within a peripheral region of a sheet. In the example of FIG. 16, too, the overlap between the display object 511Y and the auxiliary content 542 has been resolved. When the user has operated the switch button 612 again, the UI control unit 223 can change the arrangement of the tone patterns 320Y, 320M, 320C, and 320K from the second arrangement to the first arrangement, which has been described using FIG. 11.

### <5. Summary>

Thus far, various embodiments, embodiment examples, and modified examples have been described using FIG. 1 to FIG. 16. According to the above-described embodiments, prior to the execution of a print job, the user can change the arrangement of patterns for adjustment as appropriate while confirming, on the preview screen, the positional relationship between content that they have arranged by themselves and the patterns for adjustment formed by the image-forming apparatus. That is to say, the user can avoid an overlap between the patterns for adjustment used in the adjustment of image-forming conditions and content image of the user through an interaction with the system.

### <6. Other Embodiments>

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-216194, filed on Dec. 21, 2023 which is hereby incorporated by reference herein in its entirety.

What is claimed is:

1. An image-forming apparatus, comprising:
an image-forming unit configured to form a user image on a sheet based on at least one image-forming condition;
a reading unit configured to generate a read image by optically reading the sheet; and
a control unit configured to cause a display unit to display a preview screen related to the user image formed by the image-forming unit,
wherein the image-forming unit is capable of forming a pattern for adjustment on the sheet together with the user image, the pattern for adjustment being used for adjustment of the at least one image-forming condition,
the pattern for adjustment is arranged in an end section of the sheet in a main-scanning direction or an end section of the sheet in a sub-scanning direction that is perpendicular to the main-scanning direction,
the image-forming apparatus further comprises an adjustment unit configured to adjust the at least one image-forming condition based on a result of detection of the pattern for adjustment in the read image generated by the reading unit,
the control unit is configured to cause the preview screen to display a display object representing the pattern for adjustment in accordance with an arrangement of the pattern for adjustment on the sheet, and
the control unit is configured to, in response to a user input for instructing to change the arrangement of the pattern for adjustment,
change the arrangement of the pattern for adjustment on the sheet from one of the end section in the main-scanning direction and the end section in the sub-scanning direction to the other, and
cause the display object to be displayed on the preview screen in accordance with the changed arrangement of the pattern for adjustment.

2. The image-forming apparatus according to claim 1, wherein the image-forming unit is capable of forming the pattern for adjustment in a trimming region of the sheet to be trimmed off.

3. The image-forming apparatus according to claim 2, wherein the pattern for adjustment is arranged at both ends in the main-scanning direction in a first arrangement, and arranged at both ends in the sub-scanning direction in a second arrangement.

4. The image-forming apparatus according to claim 3, wherein
the pattern for adjustment includes a plurality of patch images arrayed along a longitudinal direction of the pattern for adjustment,
in the first arrangement, the longitudinal direction of the pattern for adjustment is parallel to the sub-scanning direction, and
in the second arrangement, the longitudinal direction of the pattern for adjustment is parallel to the main-scanning direction.

5. The image-forming apparatus according to claim 4, further comprising
a correction unit configured to correct density unevenness of an image formed by the image-forming unit in the main-scanning direction,
wherein the control unit is configured to cause the correction unit to correct density unevenness in the main-scanning direction in a case where the second arrangement is set as the arrangement of the pattern for adjustment.

6. The image-forming apparatus according to claim 5, wherein
the at least one image-forming condition includes a condition related to density of an image formed by the image-forming unit, and
the plurality of patch images in the pattern for adjustment include two or more patch images with different tones.

7. The image-forming apparatus according to claim 1, wherein
the image-forming unit is capable of forming an image on a sheet of a first size and a sheet of a second size smaller than the first size, and
the control unit is configured to
allow the user input to be accepted in a case where the image-forming unit has been set to form an image on a sheet of the first size, and
not allow the user input to be accepted in a case where the image-forming unit has been set to form an image on a sheet of the second size.

8. The image-forming apparatus according to claim 1, further comprising the display unit.

9. The image-forming apparatus according to claim 1, further comprising a communication unit configured to perform communication with another apparatus including the display unit.

10. A method executed by an image-forming apparatus, the method comprising:
forming a pattern for adjustment on a sheet together with a user image, the pattern for adjustment being used for adjustment of at least one image-forming condition;
obtaining a read image generated by optically reading the sheet;
adjusting the at least one image-forming condition based on a result of detection of the pattern for adjustment in the read image; and
causing a display apparatus to display a preview screen related to the user image prior to the formation of the pattern for adjustment on the sheet together with the user image,
wherein the pattern for adjustment is arranged in an end section of the sheet in a main-scanning direction or an end section of the sheet in a sub-scanning direction that is perpendicular to the main-scanning direction,
the preview screen includes a display object representing the pattern for adjustment, the display object being arranged in accordance with an arrangement of the pattern for adjustment on the sheet, and
the method further comprises:
accepting a user input for instructing to change the arrangement of the pattern for adjustment, and
in response to the user input,
changing the arrangement of the pattern for adjustment on the sheet from one of the end section in the main-scanning direction and the end section in the sub-scanning direction to the other, and
causing the display object to be displayed on the preview screen in accordance with the changed arrangement of the pattern for adjustment.

11. A display apparatus, comprising:
a display unit; and
a display control unit configured to cause the display unit to display a preview screen related to a user image to be formed by an image-forming apparatus,
wherein the display control unit is configured to cause a display object representing a pattern for adjustment used for adjustment of at least one image-forming condition in the image-forming apparatus to be displayed on the preview screen in accordance with an arrangement of the pattern for adjustment on a sheet, the pattern for adjustment being formed together with the user image on the sheet, and
the display control unit is configured to accept, via the preview screen, a user input for instructing to change an arrangement of the pattern for adjustment from one of an end section of the sheet in a main-scanning direction and an end section of the sheet in a sub-scanning direction that is perpendicular to the main-scanning direction to the other.

12. The display apparatus according to claim 11, wherein the display control unit is configured to, in a case where the user input for instructing to change an arrangement of the pattern for adjustment is accepted, cause the display object to be displayed on the preview screen in accordance with the changed arrangement of the pattern for adjustment.

13. The display apparatus according to claim 11, wherein the pattern for adjustment is arranged at both ends in the main-scanning direction in a first arrangement, and arranged at both ends in the sub-scanning direction in a second arrangement.

14. The display apparatus according to claim 11, wherein
the image-forming apparatus is capable of forming an image on a sheet of a first size and a sheet of a second size smaller than the first size, and
the display control unit is configured to
allow the user input to be accepted via the preview screen in a case where the image-forming apparatus has been set to form an image on a sheet of the first size, and
not allow the user input to be accepted via the preview screen in a case where the image-forming apparatus has been set to form an image on a sheet of the second size.
